(19) United States
(12) Patent Application Publication
(10) Pub. No.: US 2014/0283676 A1
(43) Pub. Date: Sep. 25, 2014

(54) Fluid Regeneration in a Hydraulic System

(71) Applicant: CATERPILLAR INC., Peoria, IL (US)

(72) Inventor: Matt Beschorner, Plainfield, IL (US)

(73) Assignee: Caterpillar Inc., Peoria, IL (US)

(21) Appl. No.: 13/848,580

(22) Filed: Mar. 21, 2013

(51) Int. Cl. F15B 15/02

(52) U.S. Cl. CPC F15B 15/02
USPC 91/418; 91/471

(57) ABSTRACT

A hydraulic system for a work machine may include a first hydraulic cylinder, a second hydraulic cylinder and a monospool assembly in fluid communication with the first hydraulic cylinder and the second hydraulic cylinder. The monospool assembly may facilitate at least one of a cylinder-to-cylinder regeneration flow, makeup flow and supplemental flow to at least one of the first hydraulic cylinder and the second hydraulic cylinder.

### TECHNICAL FIELD OF THE DISCLOSURE

The present disclosure relates to a hydraulic system and, more particularly, relates to regenerating flow from one circuit to another circuit, providing supplemental flow and/or makeup flow using a monospool assembly in a hydraulic system.

### BACKGROUND OF THE DISCLOSURE

A variety of work machines such as, loaders, excavators, motor graders, and other types of construction, work, agriculture and earth moving machines use one or more hydraulically actuatable implements for accomplishing a task. These hydraulically actuatable implements may be operated by one or more hydraulic actuators such as a cylinder and a piston assembly that divides the cylinder into two chambers. The cylinder may be in fluid communication with a hydraulic pump for providing pressurized fluid to the chambers thereof, as well as in fluid communication with a fluid source or a tank for draining pressurized fluid therefrom. A valve arrangement may be connected between the pump and the cylinder and between the cylinder and the fluid source to control the flow rate and direction of the pressurized fluid to and from the chambers of the cylinder.

Each of the valve arrangements may include one or more electrically actuated compensated valves such as, independent metering valves (IMVs) that may be independently actuated to control the flow of pressurized fluid between the pump and the fluid source via the chambers of the cylinder. The amount of the pressurized fluid flowing to/from the cylinder may be controlled by changing the displacement of a valve spool in each valve. Each valve spool may typically include a series of metering slots that control the amount of fluid flowing through that valve. Changing the displacement of the valve spool may be accomplished by using an electrically controlled solenoid wound around an armature. When current is applied to the solenoid, the armature may be moved under electro-magnetic forces generated by the solenoid to cause the associated valve spool to displace a certain amount.

The fluid draining from the cylinder to the fluid source often has a pressure that is greater than the pressure of fluid already within the tank, especially when the movement of the piston is assisted by the pull of gravity and a weight of the work implement and associated load. By draining this highly pressurized fluid from the cylinder into the low pressure tank, the energy of the fluid may be wasted and the efficiency of the hydraulic system may be reduced. Instead of wasting the energy of this highly pressurized fluid and re-pressurizing it before directing the fluid back to the same or another cylinder, the draining pressurized fluid may be transferred directly to another chamber of the same cylinder or to another cylinder within the hydraulic system without first draining into the tank. This transfer of fluid from one cylinder to another cylinder of from one chamber to another chamber within the same cylinder is often termed as fluid regeneration.

Fluid regeneration may either be a cylinder-to-cylinder regeneration in which the highly pressurized draining from one cylinder is directed to another cylinder or it may be in-cylinder regeneration in which the fluid draining from one chamber of a cylinder is provided to another chamber of the same cylinder. By virtue of utilizing fluid regeneration, not only the efficiency of the hydraulic system can be increased, the efficiency of the associated work implement may be increased as well.

The present disclosure, therefore, provides one technique of facilitating the cylinder-to-cylinder and in-cylinder fluid regeneration for increasing the efficiency of the hydraulic system.

### SUMMARY OF THE DISCLOSURE

In accordance with one aspect of the present disclosure, a hydraulic system is disclosed. The hydraulic system may include a first hydraulic cylinder, a second hydraulic cylinder, a first valve arrangement in fluid communication with the first hydraulic cylinder, a second valve arrangement in fluid communication with the second hydraulic cylinder and a monospool assembly in fluid communication with the first hydraulic cylinder and the second hydraulic cylinder. The monospool assembly may be capable of facilitating at least one of a cylinder-to-cylinder regeneration flow, makeup flow and supplemental flow to at least one of the first hydraulic cylinder and the second hydraulic cylinder.

In accordance with another aspect of the present disclosure, a method of regenerating fluid using a hydraulic system is disclosed. The method may include providing a first hydraulic cylinder, a second hydraulic cylinder, a first valve arrangement in fluid communication with the first hydraulic cylinder, a second valve arrangement in fluid communication with the second hydraulic cylinder and a monospool assembly in fluid communication with both the first hydraulic cylinder and the second hydraulic cylinder. The monospool assembly may be capable of facilitating a cylinder-to-cylinder regeneration flow between the first hydraulic cylinder and the second hydraulic cylinder. The method may also include directing regenerative fluid from the monospool assembly to the other of the one of the first hydraulic cylinder and the second hydraulic cylinder in case of the cylinder-to-cylinder regeneration.

In accordance with yet another aspect of the present disclosure, a work machine is disclosed. The work machine may include an engine, a work implement and a hydraulic system for operating the work implement. The hydraulic system may include (a) a first hydraulic cylinder; (b) a second hydraulic cylinder; (c) a first valve arrangement in fluid communication with the first hydraulic cylinder; (d) a second valve arrangement in fluid communication with the second hydraulic cylinder; (e) a monospool assembly in fluid communication with both the first hydraulic cylinder and the second hydraulic cylinder, the monospool assembly capable of facilitating at least one of a cylinder-to-cylinder regeneration flow, makeup flow and supplemental flow to at least one of the first hydraulic cylinder and the second hydraulic cylinder.

These and other aspects and features of the present disclosure will be more readily understood upon reading the following description when taken in conjunction with the accompanying drawings.

### BRIEF DESCRIPTION OF THE DRAWINGS

FIG. 1 is a schematic illustration of an exemplary hydraulic excavator having a hydraulic system, in accordance with at least some embodiments of the present disclosure;

FIG. 2A is a schematic illustration of the hydraulic system of FIG. 1 showing a first configuration of a combiner valve;

FIG. 2B is a schematic illustration of the hydraulic system of FIG. 1 showing a second configuration of the combiner valve;

FIG. 3A is a first exemplary flow diagram showing cylinder-to-cylinder regeneration flow of hydraulic fluid from a head-end chamber of a first hydraulic cylinder to a rod-end chamber of a second hydraulic cylinder using a monospool assembly in the hydraulic system of FIG. 2;

FIG. 3B is a second exemplary flow diagram showing the cylinder-to-cylinder regeneration flow of hydraulic fluid from the head-end chamber of the first hydraulic cylinder to a head-end chamber of the second hydraulic cylinder using the monospool assembly in the hydraulic system of FIG. 2;

FIG. 3C is a third exemplary flow diagram showing the cylinder-to-cylinder regeneration flow of hydraulic fluid from a rod-end chamber of the first hydraulic cylinder to the head-end chamber of the second hydraulic cylinder using the monospool assembly in the hydraulic system of FIG. 2;

FIG. 3D is a fourth exemplary flow diagram showing the cylinder-to-cylinder regeneration flow of hydraulic fluid from the rod-end chamber of the first hydraulic cylinder to the rod-end chamber of the second hydraulic cylinder using the monospool assembly in the hydraulic system of FIG. 2;

FIG. 4A is an exemplary flow diagram showing in-cylinder regeneration flow of hydraulic fluid from the head-end chamber to the rod-end chamber of the second hydraulic cylinder with supplemental flow using the monospool valve in the hydraulic system of FIG. 2; and

FIG. 4B is another exemplary flow diagram showing cylinder-to-cylinder regeneration flow of fluid from the head-end chamber of the first hydraulic cylinder to the head-end chamber of the second hydraulic cylinder with makeup flow using the monospool valve in the hydraulic system of FIG. 2.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents along within the spirit and scope of the present disclosure.

### DETAILED DESCRIPTION OF THE DISCLOSURE

The present disclosure discloses a hydraulic system that permits regeneration of pressurized fluid from a hydraulic cylinder in one circuit to a hydraulic cylinder in another circuit. The hydraulic system may utilize a monospool assembly to facilitate the regeneration of pressurized fluid, as described below. The monospool assembly may also be utilized to provide additional flow or tank capacity in the form of supplemental flow and makeup flow, as also described below.

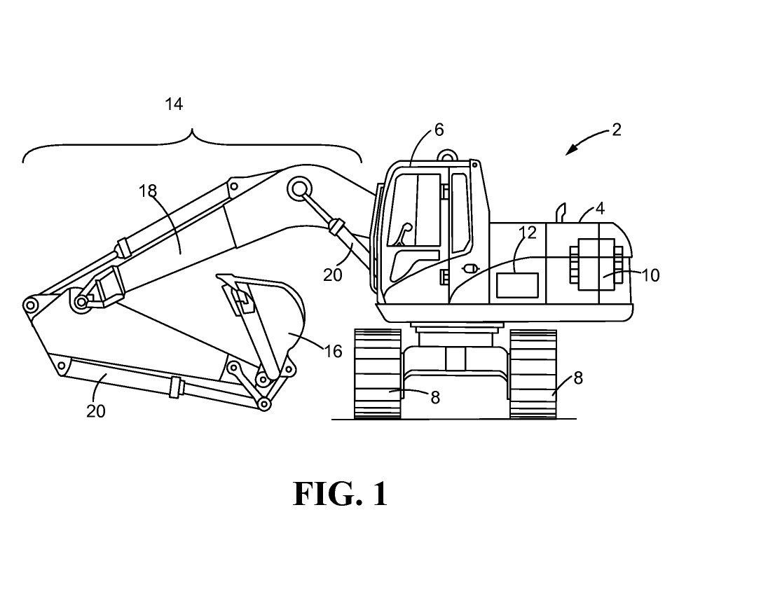

Referring now to FIG. 1, an exemplary work machine 2 is shown, in accordance with at least some embodiments of the present disclosure. While the work machine 2 has been shown to be a hydraulic excavator, it will be understood that in other embodiments, the work machine may be a wheel loader, skid-steer loader, a backhoe-loader, a track or wheel type tractor or loader, a harvester, a paving machine, or any other type of work, construction, agricultural, mining or earth moving machine that utilizes a hydraulically actuatable implement for accomplishing a task.

The work machine 2 may include an engine frame structure 4 connected at least indirectly to an operator station 6. Tracks 8 or other ground engaging mechanisms (such as wheels) may be employed for navigating the work machine 2. The engine frame structure 4 may house a power source, such as an engine 10 and other power train components (such as a transmission, not shown) for generating and delivering power to operate the work machine 2. The engine may be a gasoline, diesel, or any other type of engine that is commonly employed with such work machines. The work machine 2 may even draw power from other power sources, such as natural gas, fuel cells, etc. The engine frame structure 4 may also house a hydraulic system 12 for hydraulically actuating an implement system 14.

The implement system 14 may include a work implement, such as a bucket 16. The bucket 16 may be configured for secure attachment to the work machine 2, and for release and substitution of another implement when desired. The bucket 16 may be connected for operation to the engine frame structure 4 by one or more lift arms 18. The operation of the lift arms 18 may be controlled by one or more actuators, such as, hydraulic cylinders 20. The hydraulic cylinders 20 may be extended or retracted to operate the lift arms 18. The operation of the hydraulic cylinders 20 may in turn be controlled by the hydraulic system 12 under command by an operator operating the work machine 2.

With respect to the operator station 6, although not visible, it may include a plurality of operator controls and operator interfaces for controlling the operation of the work machine 2 and the various work implements connected thereto, as well as for navigating and steering the work machine on a work surface. For instance, the operator station 6 may house various hand controlled operator interfaces, such as, joystick controls, pedals, buttons, instrument panels, gauges and warning lamps for keeping the operator aware of any critical system information, as well as safety and convenience features such as cup holders, lighters, etc. Other devices and components that commonly exist may be present in the operator station 6 of the work machine 2.

Notwithstanding the components of the work machine 2 described above, it will be understood that several other components of the work machine, as well as components that may be employed in combination or conjunction with the work machine are contemplated and considered within the scope of the present disclosure.

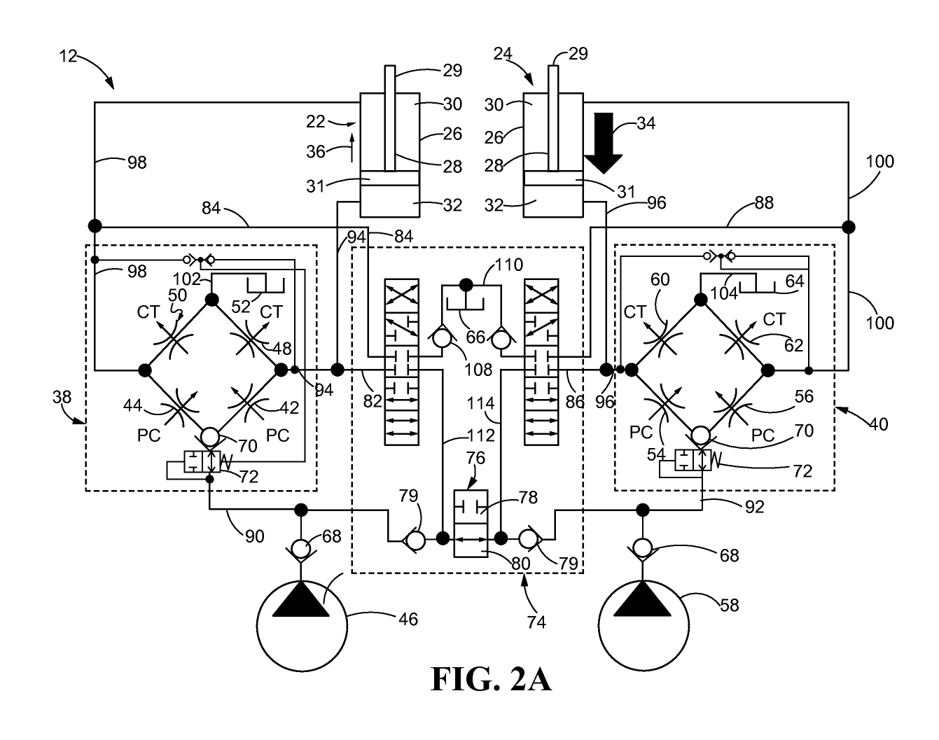

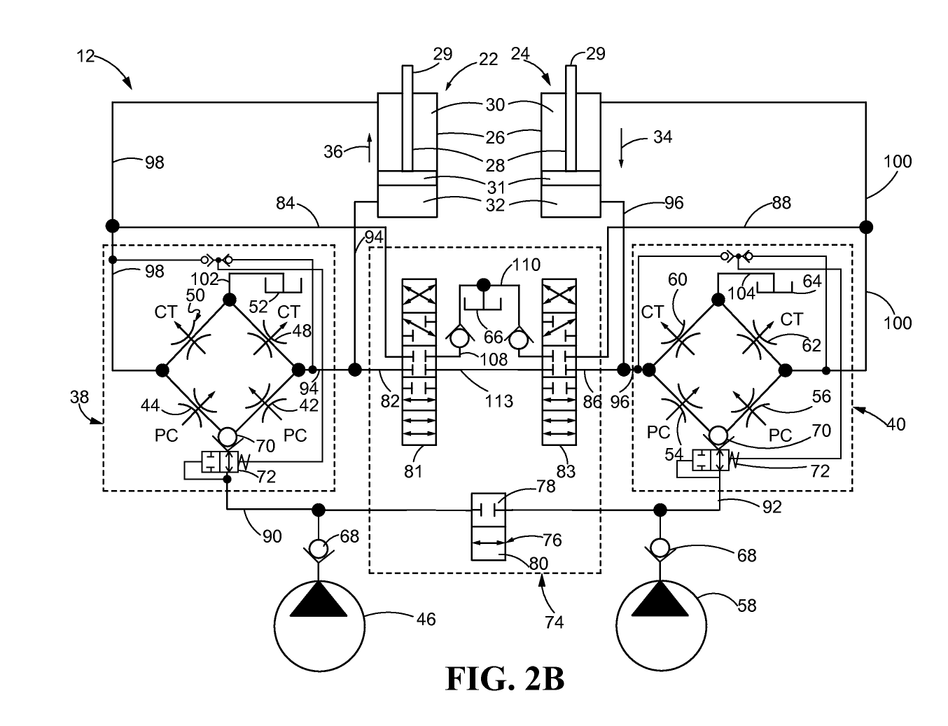

Turning now to FIGS. 2A and 2B, the hydraulic system 12, in accordance with at least some embodiments of the present disclosure, is shown. Referring to both FIGS. 2A and 2B, the hydraulic system 12 may include a first hydraulic cylinder 22 and a second hydraulic cylinder 24, each of the first and the second hydraulic cylinders in fluid communication with one another. In at least some embodiments, the first and the second hydraulic cylinders 22 and 24, respectively, may be representative of the hydraulic cylinders 20 above and may be utilized to operate the implement system 14. In other embodiments, one or both of the first hydraulic cylinder 22 and the second hydraulic cylinder 24 may be utilized to perform other hydraulic functions related to the work machine 2. Although only two hydraulic cylinders, namely, the first hydraulic cylinder 22 and the second hydraulic cylinder 24, have been shown here and the operation of the hydraulic system 12 has been described with respect to those hydraulic cylinders, in at least some embodiments, more than two hydraulic cylinders or possibly even a single hydraulic cylinder may be provided within the hydraulic system.

Each of the first hydraulic cylinder 22 and the second hydraulic cylinder 24 may include a tube or barrel 26 closed on both ends thereof and a piston assembly 28 disposed within the barrel. The piston assembly 28 may include a rod end 29 and a head end 31 and may divide the barrel 26 into two chambers, namely, a rod-end chamber 30 closer to the rod end of the hydraulic cylinders and a head-end chamber 32 closer to the head end of the hydraulic cylinders. One or both of the rod-end and the head-end chambers 30 and 32, respectively, may be supplied with pressurized fluid or pressurized fluid may be drained therefrom to create a pressure differential between those chambers and causing the piston assembly 28 to be displaced axially within the barrel 26. By virtue of moving the piston assembly 28, the first hydraulic cylinder 22 and the second hydraulic cylinder 24 may be retracted (indicated by arrow 34) or expanded (indicated by arrow 36). Retraction or expansion of the first hydraulic cylinder 22 and the second hydraulic cylinder 24 may result in moving the implement system 14 or accomplishing other hydraulically actuatable tasks.

In order to supply pressurized fluid to and drain pressurized fluid from the first and the second hydraulic cylinders 22 and 24, respectively, the hydraulic system 12 may include one or more valve arrangements, such as a first valve arrangement 38 and a second valve arrangement 40. The first valve arrangement 38 may be associated with the first hydraulic cylinder 22 and may include a head-end supply valve 42 and a rod-end supply valve 44 for supplying pressurized fluid from a first pump 46 to the head-end and rod-end, respectively, of the hydraulic cylinder, as well as a head-end drain valve 48 and a rod-end drain valve 50 for draining pressurized fluid from the head-end and rod-end, respectively, of the hydraulic cylinder to a first tank 52. Relatedly, the second valve arrangement 40 may be associated with the second hydraulic cylinder 24 and may include a head-end supply valve 54 and a rod-end supply valve 56 for supplying pressurized fluid from a second pump 58 to the head-end and rod-end, respectively, of the hydraulic cylinder, as well as a head-end drain valve 60 and a rod-end drain valve 62 for draining pressurized fluid from the head-end and rod-end, respectively, of the hydraulic cylinder to a second tank 64.

Since each of the head-end supply valves 42 and 54, and the rod-end supply valves 44 and 56 may be utilized to supply hydraulic fluid from the first pump 46 and the second pump 58, respectively, to the respective first hydraulic cylinder 22 and the second hydraulic cylinder 24, these valves may be termed as pump-to-cylinder (PC) valves. Relatedly, since the head-end drain valves 48, 60 and the rod-end drain valves 50, 62 may be utilized to drain hydraulic fluid from the first hydraulic cylinder 22 and the second hydraulic cylinder 24, respectively, to the respective first tank 52 and the second tank 64, these valves may be termed as cylinder-to-tank (CT) valves.

The flow of pressurized fluid between the first pump 46 and the first tank 52 via the first valve arrangement 38 and the first hydraulic cylinder 22, as well as between the second pump 58 and the second tank 64 via the second valve arrangement 40 and the second hydraulic cylinder 24, may occur through various fluid passages, which are described in greater detail below. It will be understood that while in the present embodiment, each of the first and the second valve arrangements 38 and 40, respectively, have been shown as having a pair of supply valves and a pair of drain valves, in at least some other embodiments, greater or fewer than two of each type of valves may be present. Furthermore, in at least some embodiments, each of the valves 42, 44, 48, 50, 54, 56, 60 and 62 may be a pressure compensated independent metering valve (IMV) capable of independent operation. In other embodiments, other types of valves suitable for use within a hydraulic system and appropriate for the particular type of application may be utilized as well.

Additionally, each of the valves 42, 44, 48, 50, 54, 56, 60 and 62 may be an electrically actuatable valve having a valve poppet or valve spool (not shown) and an actuator (also not shown) to control the flow of pressurized fluid (e.g., flow rate) through the respective valve by moving the valve spool to a desired position using electric current. More specifically, in order to control the movement (e.g., displacement) of the valve spool, the actuator may be electrically controlled (e.g., by a control system not shown) with an armature having a solenoid wound therearound, such that by applying a current signal to the solenoid, the actuator may be actuated to displace the valve spool and vary the fluid rate of pressurized fluid through the valves 42, 44, 48, 50, 54, 56, 60 and 62. In other embodiments, other types of actuators may be employed as well. Furthermore, in at least some embodiments, one or more of the valves 42, 44, 48, 40, 54, 56, 60 and 62 may be controlled by an electronic control module (ECM), not shown in the figures. Similarly, one or both of the valve assemblies 38 and 40 may include line relief valves (not shown).

With respect to the first pump 46 and the second pump 58, each of these pumps may supply pressurized fluid from one or more of the first tank 52, the second tank 64 and a third tank 66 to the first and second hydraulic cylinders 22 and 24. The first and the second pumps 46 and 58, respectively, may be fixed or variable displacement pumps, although other types of pumps that are commonly employed in hydraulic systems may be employed as well. Each of the first pump 46 and the second pump 58 may also have associated therewith a check valve 68. The check valve 68 may be a one way spring loaded (not shown) check valve to ensure a single direction flow of fluid—away from the respective first and the second pumps 46 and 58. Additionally, while only one of the first pump 46 and one of the second pump 58 have been shown, in at least some embodiments, more than one pump for each of the first and/or the second pump may be employed as well. In yet other embodiments, a single one of the pumps may be employed in lieu of the first pump 46 and the second pump 58.

The first cylinder 22, the first valve arrangement 38, the first pump 46 and the first tank 52 may constitute a first hydraulic circuit (referred to herein as simply a “first circuit”), while the second cylinder 24, the second valve arrangement 40, the second pump 58 and the second tank 64 may constitute a second hydraulic circuit (referred to herein as simply a “second circuit”). Furthermore, notwithstanding the fact that the first, second and the third tanks 52, 64 and 66, respectively, have been shown to be separate from one another, in at least some embodiments, those tanks may be connected and may all be representative of one single tank from which the first and the second pumps 46 and 58, respectively, may supply fluid to the first hydraulic cylinder 22 and the second hydraulic cylinder 24. Moreover, one or more of the first tank 52, the second tank 64 and the third tank 66 may be reservoirs or other types of fluid sources that may be capable of storing a supply of fluid, such as, hydraulic fluid, lubrication oil, transmission oil or other types of machines oils and fluids utilized within the work machine 2.

Referring still to FIGS. 2A and 2B together, in addition to the components described above, the hydraulic system 12 may also include a check valve 70, a pre-compensator 72 and a monospool assembly 74. With respect to the check valve 70, similar to the check valve 68, it may be a one-way valve employed to ensure that pressurized fluid from the first valve arrangement 38 and the second valve arrangement 40 does not flow towards the first pump 46 and the second pump 58. The pre-compensator 72, on the other hand, may be a mechanical device utilized to determine a pressure differential and to ensure a constant flow of pressurized fluid irrespective of any changes in pressure to get a near constant flow velocity. The check valves 68 and 70, as well as the pre-compensator 72 are well known in the art and have, therefore, not been described here in greater detail. Furthermore, notwithstanding the locations of the check valve 70 and the pre-compensator 72 shown in FIG. 2, it will be understood that the check valves and pre-compensators may be present in other locations of the hydraulic system 12, as required. Relatedly, in some embodiments, those components may not be utilized at all.

With respect to the monospool assembly 74, it may be a directional control valve for facilitating regeneration flow, supplemental flow and makeup flow. For example, the monospool assembly 74 may be utilized to facilitate the flow of pressurized fluid along multiple paths between the first hydraulic cylinder 22 and the second hydraulic cylinder 24, such as cylinder-to-cylinder regeneration flow (e.g., flow of pressurized fluid between the first circuit and the second circuit). The monospool assembly 74 may also be utilized to provide supplemental flow (e.g., flow from the first pump 46 and/or the second pump 58) and/or makeup flow (e.g., flow from the tanks 52, 64 and 66 when back pressure on those tanks is greater than cylinder port pressure and when regeneration flow and supplemental flow are insufficient) in addition to cylinder-to-cylinder regeneration flow. The monospool assembly 74 may also be employed in providing supplemental and/or makeup flow during in-cylinder regeneration flow (e.g., from one chamber to the other chamber of the same circuit). Thus, the monospool assembly 74 may facilitate at least three types of flows: (A) cylinder-to-cylinder regeneration flow; (B) supplemental flow from the first and the second pumps 46 and 58, respectively, for both cylinder-to-cylinder regeneration flow and in-cylinder flow; and (C) makeup flow from the tanks 52, 64 and 66 for both cylinder-to-cylinder regeneration flow and in-cylinder regeneration flow.

The monospool assembly 74 may include monospool stems, such as a first monospool stem 81 and a second monospool stem 83. Each of the first and the second monospool stems 81 and 83, respectively, may include several stem positions. For example and as shown, each of the first monospool stem 81 and the second monospool stem 83 may include five positions for transferring pressurized hydraulic fluid from one hydraulic circuit to another hydraulic circuit or to provide makeup and supplemental flows. Notwithstanding the fact that in the present embodiment, the first and the second monospool stems 81 and 83, respectively, have been shown with five stem positions, the number of positions may change depending upon the various paths of fluid flow that are desired. Furthermore, the number of monospool stems may vary as well, typically using one monopsool stem for each valve arrangement. Also, although not shown, the monospool assembly 74 may also include relief valves and/or line relief valves. The monospool assembly 74 may also include the third tank 66, which may be utilized to provide makeup flow when supplemental flow (from the pumps 46, 58) and/or regeneration flow is insufficient.

The monospool assembly 74 may further include a combiner valve 76 having a first position 78 and a second position 80 for facilitating supplemental flow, as well as cylinder-to-cylinder regeneration flow. The combiner valve 76 may be connected within the hydraulic system 12 in several different ways, two of which are shown in FIGS. 2A and 2B. Specifically, as shown in FIG. 2A, the combiner valve 76 may be connected to the monospool assembly 74, as well as to the first pump 46 and the second pump 58. Through such a connection, regeneration flow of hydraulic fluid between the first circuit and the second circuit (cylinder-to-cylinder regeneration flow) may occur via the first and second monospool stems 81 and 83, respectively, and through the combiner valve 76. In addition, the combiner valve 76 may be utilized to provide supplemental flow from the first pump 46 to the second hydraulic cylinder 24 and/or from the second pump 58 to the first hydraulic cylinder 22 via the monospool the first monospool stem 81 and the second monospool stem 83. Check valves 79 ensure that the both the regeneration flow and the supplemental flow of pressurized fluid through the combiner valve 76 occurs via the monospool stems 81 and 83. The check valves 79 may also prevent flow of pressurized fluid from the monospool assembly 74 to the first pump 46 and the second pump 58.

Thus, in the configuration of FIG. 2A, the first position 78 of the combiner valve 76 may be utilized for restricting supplemental flow of pressurized fluid from the first pump 46 towards the second hydraulic cylinder 24 and from the second pump 58 towards the first hydraulic cylinder 22 via the monospool assembly 74. The first position 78 may also be used to restrict cylinder-to-cylinder regeneration flow between the first circuit and the second circuit. In addition the first position 78 may be utilized to isolate the first pump 46 and the second pump 58 as well when fully closed. The second position 80, on the other hand, may be utilized for facilitating regeneration and supplemental flow of pressurized fluid. Specifically, in the second position 80, the combiner valve 76 may allow regeneration flow between the first circuit and the second circuit, as well as supplemental flow from the first pump 46 towards the second hydraulic cylinder 24 and/or from the second pump 58 towards the first hydraulic cylinder 22.

In contrast, the configuration of FIG. 2B bypasses the monospool stems 81 and 83 and thus, only provides for supplemental flow. The configuration of FIG. 2B may also provide circuit-to-circuit regeneration flow through the first valve arrangement 38 and the second valve arrangement 40 via the monospool valve 74. In the second position 80, the combiner valve 76 may permit supplemental flow from the first pump 46 to the second hydraulic cylinder 24 via the second valve arrangement 40 and from the second pump 58 to the first hydraulic cylinder 22 via the first valve arrangement 38. In the first position 78, the combiner valve 76 may at least partially restrict (or possibly fully block) any supplemental flow from the pumps 46 and 58. The check valves 79 may also not be needed.

Furthermore, in at least some embodiments, the combiner valve 76 may be electronically controlled. In other embodiments, other types of mechanisms commonly employed may be used to control the combiner valve 76.

To provide regeneration flow, supplemental flow and makeup flow, the monospool assembly 74 may be connected to both the first hydraulic cylinder 22 and the second hydraulic cylinder 24. Specifically, the monospool assembly 74 may include a first head-end fluid passage 82 for receiving pressurized fluid from and directing pressurized fluid to the head-end chamber 32 of the first hydraulic cylinder 22 through the monospool assembly, as well as a first rod-end fluid passage 84 for receiving/directing pressurized fluid from/to the rod-end chamber 30 of the first hydraulic cylinder through the monospool assembly. Relatedly, the monospool assembly 74 may include a second head-end fluid passage 86 to facilitate the flow of pressurized fluid between the head-end chamber 32 of the second hydraulic cylinder 24 and the monospool assembly, as well as a second rod-end fluid passage 88 to facilitate the flow of pressurized flow between the rod-end chamber 30 of the second hydraulic cylinder and the monospool assembly.

In addition to the various fluid passages described above, the hydraulic system 12 may include several other fluid passages as well. For example, the hydraulic system 12 may include a fluid passage 90 for supplying pressurized fluid from the first pump 46 to the first valve arrangement 38 and a fluid passage 92 for supplying pressurized fluid from the second pump 58 to the second valve arrangement 40. Relatedly, the hydraulic system 12 may include a fluid passage 94 for supplying pressurized fluid from the head-end supply valve 42 and a fluid passage 96 for supplying pressurized fluid from the head-end supply valve 54 to the head-end chambers 32 of the first hydraulic cylinder 22 and the second hydraulic cylinder 24, respectively. Similarly, fluid passages 98 and 100 may supply pressurized fluid from the rod-end supply valves 44 and 56, respectively, to the rod-end chambers 30 of the respective first hydraulic cylinder 22 and the second hydraulic cylinder 24. Fluid may be drained into the first tank 52 from the first hydraulic cylinder 22 via a fluid passage 102 through the head-end drain valve 48 and the rod-end drain valve 50, while fluid may be drained into the second tank 64 from the second hydraulic cylinder 24 via a fluid passage 104 through the head-end drain valve 60 and the rod-end drain valve 62.

Thus, in order to supply pressurized fluid from the first pump 46 to the head-end chamber 32 of the first hydraulic cylinder 22, the fluid passages 90 and 94 may be utilized through the head-end supply valve 42, while to supply pressurized fluid from the second pump 58 to the head-end chamber 32 of the second hydraulic cylinder 24, the fluid passages 92 and 96 may be employed via the head-end supply valve 54. Pressurized fluid may be supplied to the rod-end chambers 30 of the first hydraulic cylinder 22 and the second hydraulic cylinder 24 from the first pump 46 and the second pump 58 respectively, via the respective fluid passages 90, 98 and 92, 100 through the rod-end supply valves 44 and 56, respectively. Similarly, pressurized fluid may be drained from the rod-end chamber 30 of the first hydraulic cylinder into the first tank 52 via the fluid passages 98 and 102 through the rod-end drain valve 50 and the pressurized fluid may be drained from the rod-end chamber of the second hydraulic cylinder 24 to the second tank 64 through the fluid passages 100 and 104 and the rod-end drain valve 62. Fluid may be drained from the head-end chamber 32 of the first hydraulic cylinder 22 to the first tank 52 through the fluid passages 94 and 102 through the head-end drain valve 48, while fluid may be drained from the head-end chamber of the second hydraulic cylinder 24 to the second tank 64 through the fluid passages 96 and 104 via the head-end drain valve 60.

Notwithstanding the components and fluid passages of the hydraulic system 12 described above, several other components, such as, bypass valves, pressure sensors, etc., that are commonly utilized in combination or conjunction with such hydraulic systems may be used as well and those components are considered within the scope of the present disclosure.

### INDUSTRIAL APPLICABILITY

In general, the present disclosure sets forth an electro-hydraulic system having at least one supply valve and at least one drain valve, each using a solenoid actuator to convert electrical current to main valve spool area for varying fluid flow to one or more hydraulic cylinders. The hydraulic system also utilizes a monospool assembly to facilitate regenerative flow and particularly, cylinder-to-cylinder regenerative flow and in-cylinder regenerative flow.

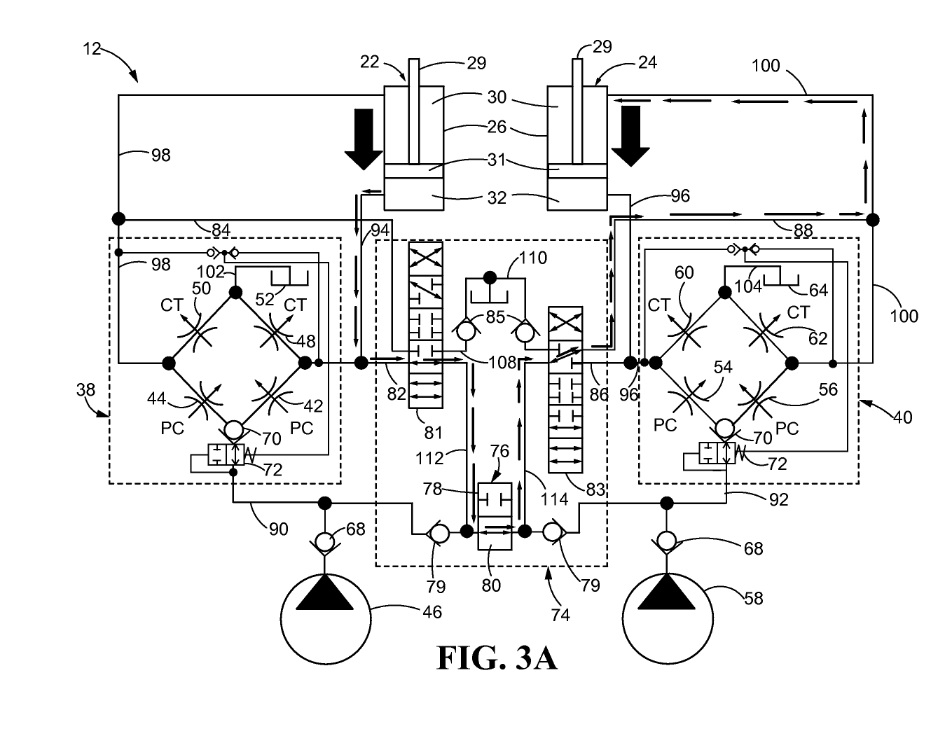

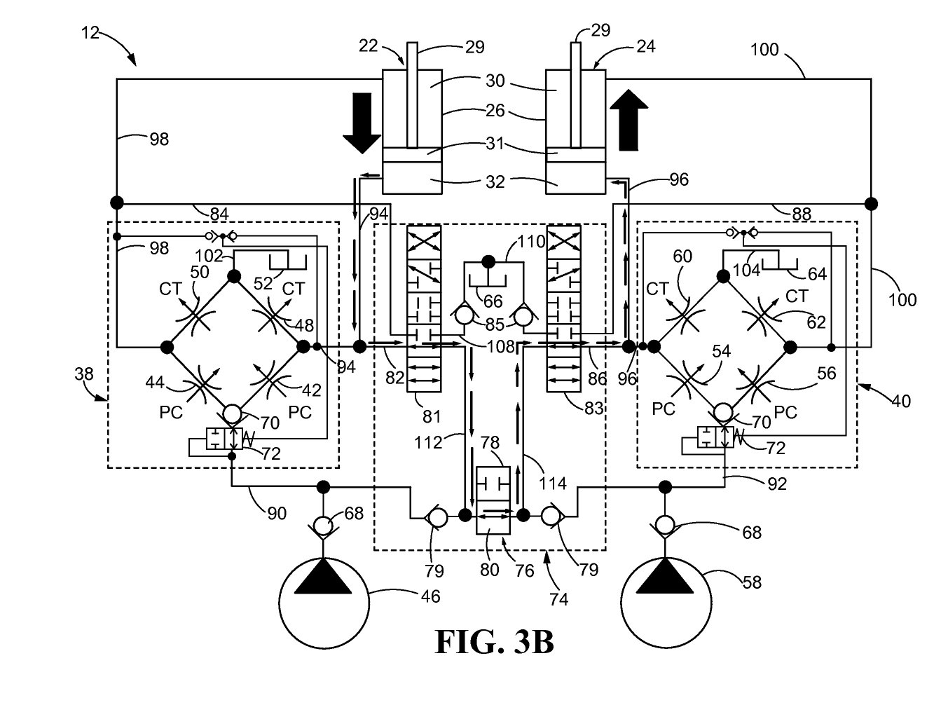

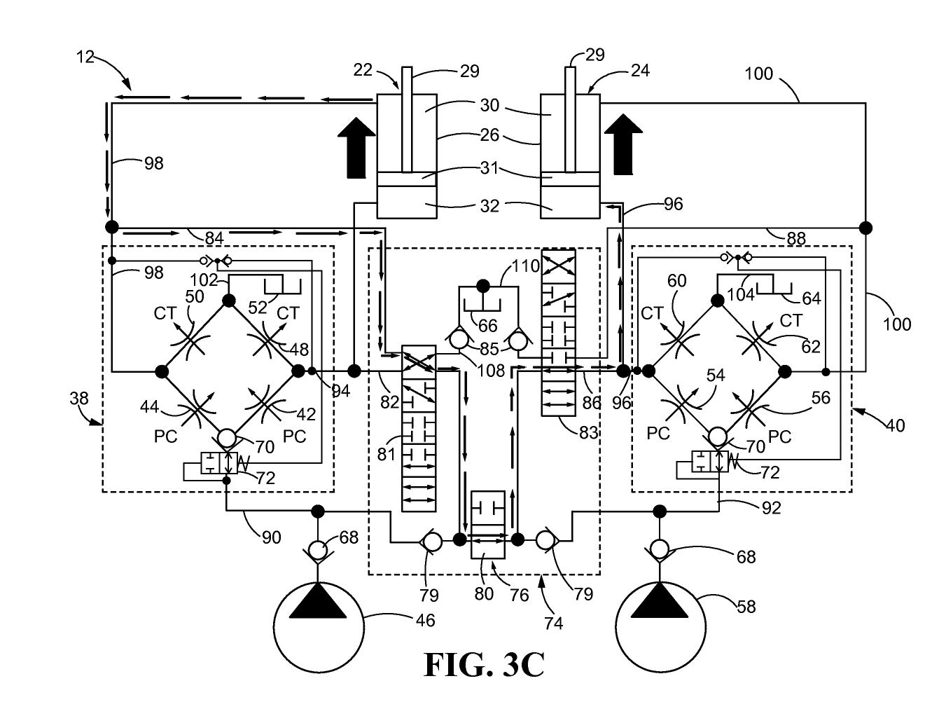

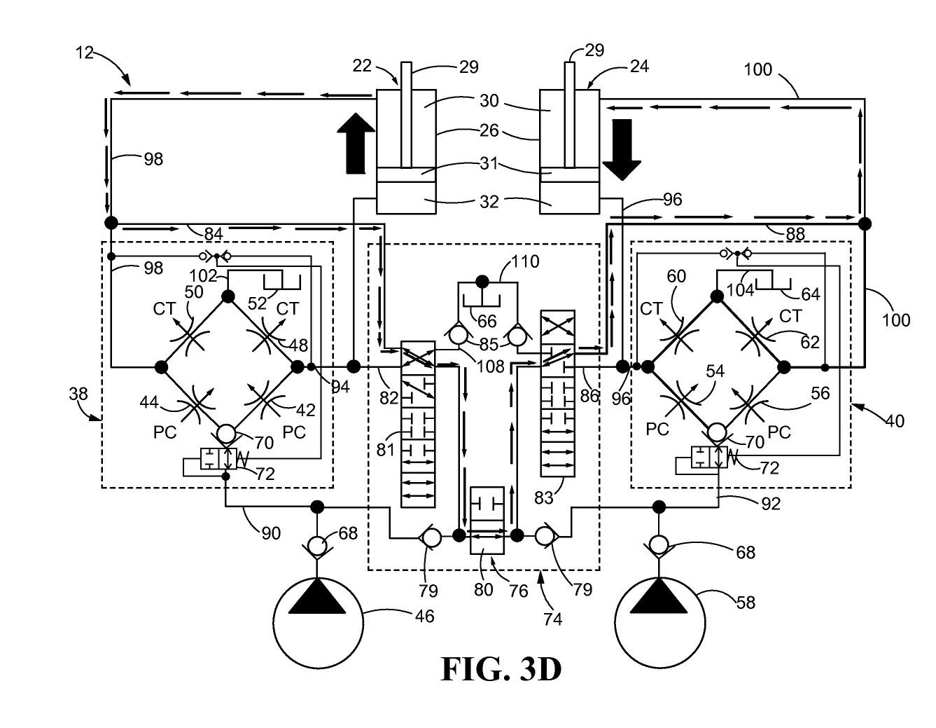

Turning now to FIGS. 3A-3D, cylinder-to-cylinder regeneration flow between the first and the second circuits is shown, in accordance with at least some embodiments of the present disclosure. Specifically, FIG. 3A shows cylinder-to-cylinder regeneration flow of fluid from the head-end chamber 32 of the first hydraulic cylinder 22 to the rod-end chamber 30 of the second hydraulic cylinder 24 using the monospool assembly 74, while FIG. 3B shows cylinder-to-cylinder regeneration flow of fluid from the head-end chamber of the first hydraulic cylinder to the head-end chamber 32 of the second hydraulic cylinder using the monospool assembly. Relatedly, FIG. 3C shows cylinder-to-cylinder regeneration flow of fluid from the rod-end chamber 30 of the first hydraulic cylinder 22 to the head-end chamber 32 of the second hydraulic cylinder 24 using the monospool assembly 74, while FIG. 3D shows cylinder-to-cylinder regeneration flow of fluid from the rod-end chamber of the first hydraulic cylinder to the rod-end chamber 30 of the second hydraulic cylinder using the monospool assembly. It will be understood that while each of FIGS. 3A-3D have been explained using the combiner valve configuration of FIG. 2A, similar flow diagrams may be obtained using the combiner valve configuration of FIG. 2B. Furthermore, while FIGS. 3A-3D have been explained in relation to regeneration of fluid from the first hydraulic cylinder 22 to the second hydraulic cylinder 24, similar flow patterns may exist for fluid regeneration from the second hydraulic cylinder to the first hydraulic cylinder.

Referring specifically now to FIG. 3A, cylinder-to-cylinder regeneration flow from the head-end chamber 32 of the first hydraulic cylinder 22 to the rod-end chamber 30 of the second hydraulic cylinder 24 may include transferring regenerative fluid via the fluid passages 94 and 82 to the monospool assembly 74 and particularly, the monospool stem 81 of the monospool assembly. The head-end drain valve 48 may be substantially closed (e.g., if no excessive regenerative fluid needs to be drained) to prevent the regenerative fluid from draining into the first tank 52. From the monospool stem 81, the regenerative fluid may be transferred to the combiner valve 76, which may be set to the second position 80 for facilitating flow from a fluid passage 112 to a fluid passage 114 for directing the regenerative fluid from the first circuit to the second circuit. From the combiner valve 76, the regenerative fluid may be directed to the rod-end chamber 30 of the second hydraulic cylinder 24 via the monospool stem 83 of the monospool assembly 74 and the fluid passages 88 and 100. The rod-end drain valve 62 (e.g., if there is no excessive fluid to be drained) and the rod-end supply valve 56 (e.g., if no supplemental flow is needed) may be substantially closed. Additional pressurized fluid may be provided, if needed, as supplemental flow by the first pump 46, the second pump 58 or a combination thereof. Further with reference to FIG. 3C discussed below, the monospool stems 81 and/or 83 in the valve assembly 74 may be shifted in position to provide makeup flow by one or more of the tanks 52, 64 and 66.

Turning now to FIG. 3B, to regenerate flow from the head-end chamber 32 of the first hydraulic cylinder 22 to the head-end chamber 32 of the second hydraulic cylinder 24, regenerative fluid may be directed from the first hydraulic cylinder to the monospool stem 81 of the monospool assembly 74 through the fluid passages 94 and 82. Thereafter, regenerative fluid may be transferred from the monospool stem 81 to the monospool stem 83 through the fluid passages 112 and 114 via the combiner valve 76 set in the second position 80 and then through the fluid passages 86 and 96 to the head-end chamber 32 of the second hydraulic cylinder 24. Again, excessive regenerative fluid may be drained to the first tank 52 and/or the third tank 66. Supplemental flow may be provided by the first pump 46 and/or the second pump 58, while the monopsool valve 74 may be shifted to provide makeup flow by one or more of the tanks 52, 64 and 66 (e.g., as shown in FIG. 3C or FIG. 3D).

FIG. 3C provides flow of regenerative fluid from the rod-end chamber 30 of the first hydraulic cylinder 22 to the head-end chamber 32. Specifically, to direct regenerative flow from the rod-end chamber 30 of the first hydraulic cylinder 22 to the head-end chamber 32 of the second hydraulic cylinder 24, regenerative fluid may be transferred to the monospool stem 81 of the monospool assembly 74 via the fluid passages 98 and 84. From the monospool stem 81 and through the combiner valve 76 set in the second position 80 and through the fluid passages 112 and 114, the regenerative fluid may be directed to the monospool stem 83. From the monospool stem 83, the regenerative fluid may be transferred to the head-end chamber 32 of the second hydraulic cylinder 24 via the fluid passages 86 and 96. Excessive regenerative fluid from the first hydraulic cylinder 22 may be drained to the first tank 52 and/or the third tank 66, while supplemental flow may be provided by the first pump 46 and/or the second pump 58 and makeup flow may be provided by one or more of the tanks 52, 64 and 66. Makeup flow may also be provided to the head-end chamber 32 of the first hydraulic cylinder 22 via the monospool stem 81.

Flow of regenerative fluid from the rod-end chamber 30 of the first hydraulic cylinder 22 to the rod-end chamber of the second hydraulic cylinder 24 may be facilitated, as shown in FIG. 3D, by first directing regenerative fluid from the first hydraulic cylinder to the monospool stem 81 (via the fluid passages 98 and 84). Thereafter, through the fluid passages 112, 114, 88 and 100, and via the monospool stem 83, the regenerative fluid may be directed to the rod-end chamber 30 of the second hydraulic cylinder 24. As discussed above, excessive regenerative fluid may be drained to the first tank 52 and/or the third tank 66, while supplemental flow may be provided by the first pump 46 and/or the second pump 58 and makeup flow may be provided by one or more of the tanks 52, 64 and 66.

It will be understood again that while the cylinder-to-cylinder regeneration flow has been described in relation to the first hydraulic cylinder 22 directing regenerative fluid to the second hydraulic cylinder 24, regenerative fluid may also be transferred from the second hydraulic cylinder to the first hydraulic cylinder utilizing the monospool assembly 74 and the various fluid passages in a similar manner as described above. Specifically, the regenerative fluid may first be directed from the second hydraulic cylinder 24 to the monospool stem 83 via various fluid passages (fluid passages 96 and 86 for regenerating fluid from the head-end chamber 32 and from fluid passages 100 and 88 for regenerating fluid from the rod-end chamber 30) and from the monospool stem 83 through the combiner valve 76 to the monospool stem 81. From the monospool stem 81, the regenerative fluid may be transferred to the first hydraulic cylinder 22 via various fluid passages (fluid passages 82 and 94 for the head-end chamber 32 and fluid passages 84 and 98 for the rod-end chamber 30).

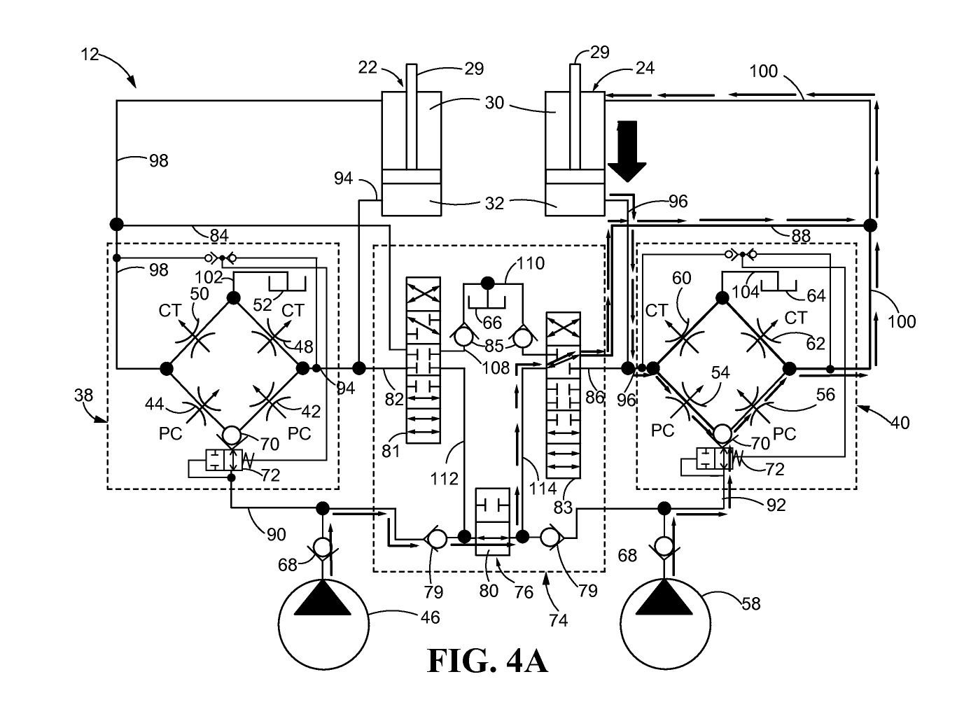

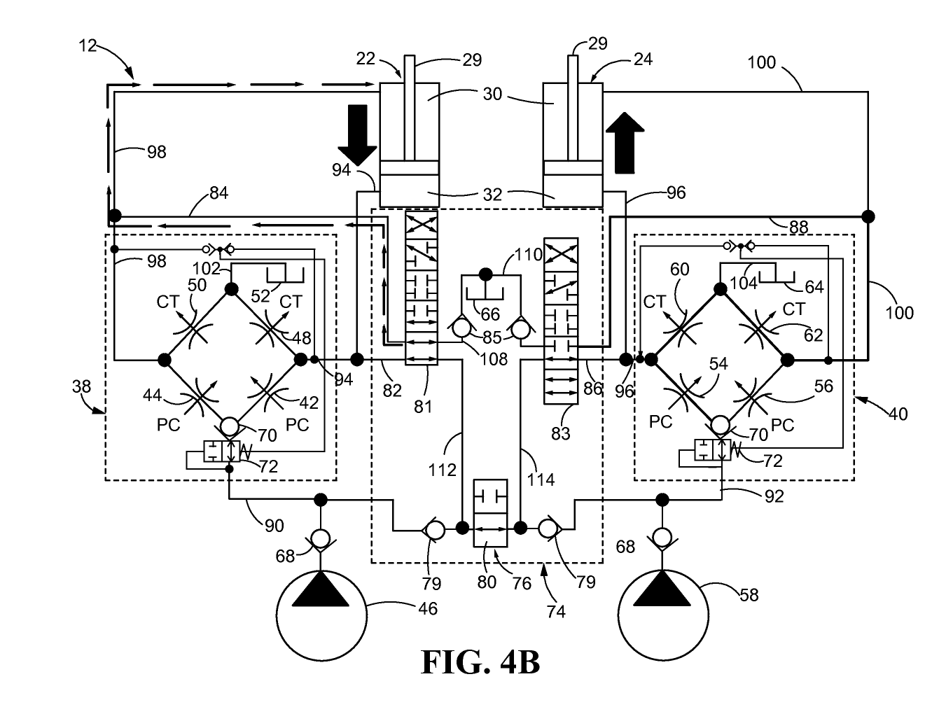

Thus, by virtue of facilitating cylinder-to-cylinder regeneration, the energy associated with the fluid being forced from the hydraulic cylinders 22 and 24 may be at least partially recouped and utilized to move the same or the other hydraulic cylinder. Furthermore, the present disclosure also provides a mechanism to increase velocity of the hydraulic cylinders using supplemental flow from the pumps and/or makeup flow from the third tank 66 when needed, as discussed below with respect to FIGS. 4A and 4B, respectively.

Referring specifically to FIG. 4A, supplemental flow is described using in-cylinder regeneration of fluid from the head-end chamber 32 to the rod-end chamber 30 of the second hydraulic cylinder 24. It will be understood that supplemental flow has been explained with respect to in-cylinder regeneration in the second hydraulic cylinder 24, in at least some embodiments, a similar supplemental flow may be provided for in-cylinder regeneration flow in the first hydraulic cylinder 22, as well as in cylinder-to-cylinder regeneration flow described above in FIGS. 3A-3D. Specifically, when the second hydraulic cylinder 24 retracts (e.g., the piston assembly 28 moves in the direction of the arrow 34), aligned with the pull of gravity, the head-end chamber 32 may be highly pressurized. Instead of draining this highly pressurized fluid into the second tank 64 and wasting the energy thereof, the fluid exiting from the head-end chamber may be regenerated and directed to the rod-end for use therein.

Particularly, to regenerate highly pressurized fluid from the head-end chamber 32 to the rod-end chamber 30 of the second hydraulic cylinder 24, the regenerative fluid may flow via the fluid passage 96 to the second valve arrangement 40. The monospool assembly 74 may not be needed in in-cylinder regeneration flow (unless as described below, supplemental flow from the first pump 46 is desired). The head-end supply valve 54 may transfer the regenerative fluid from the fluid passage 96 to the rod-end supply valve 56 and then via the fluid passage 100 to the rod-end chamber 30 of the second hydraulic cylinder 24. The head-end drain valve 60 may remain substantially closed or may be utilized to drain any excess regenerative fluid to the second tank 64. If the regenerative fluid from the head-end chamber 32 is not sufficient, then supplemental flow from one or both of the first pump 46 and the second pump 58 may be provided.

Specifically, supplemental flow from the second pump 58 may be directly supplied through the fluid passages 92 and 100 through the rod-end supply valve 56 and/or the velocity of the second hydraulic cylinder 24 may be increased by the first pump 46 through the combiner valve 76 in the second position 80, through the monospool stem 83 and via the fluid passages 88 and 100. Again, supplemental flow with respect to the in-cylinder regeneration described above is only for illustrative purposes. Similar supplemental flow may be achieved for other in-cylinder and cylinder-to-cylinder regeneration configurations.

Turning now to FIG. 4B, makeup flow from the first tank 52, the second tank 64 and/or the third tank 66 with respect to cylinder-to-cylinder regeneration flow is illustrated for regenerative fluid flowing from the head-end chamber 32 of the first hydraulic cylinder 22 to the head-end chamber of the second hydraulic cylinder 24. As described above, makeup flow from one or more of the first tank 52, the second tank 64 and the third tank 66 may be utilized when the regeneration flow from the hydraulic cylinders 22 and 24 and supplemental flow from the first pump 46 and/or the second pump 58 is not enough. In those instances, the one or more chambers of the hydraulic cylinders may exert a back pressure on the tanks 52, 64 and 66, causing a flow from the tank associated with the pressure exerting chamber to the chamber.

For example, as shown in FIG. 4B, regenerative fluid may flow from the head-end chamber 32 of the first hydraulic cylinder 22 to the head-end chamber of the second hydraulic chamber, as described above in FIG. 3B. As fluid is drained from the head-end chamber 32 of the first hydraulic cylinder 22, the rod-end chamber 30 of that hydraulic cylinder fills up with hydraulic fluid. If sufficient supply of hydraulic fluid to the rod-end chamber 30 cannot be provided by the first pump 46, then that chamber may exert a back pressure on the first tank 52 and/or the third tank 66. In that event and as shown, hydraulic fluid may flow from the third tank 66 to the rod-end chamber through the monospool stem 81 and fluid passages 84 and 98 to make up for any fluid deficiency.

It will be understood that while FIG. 4B has been explained with respect to the third tank 66 providing the makeup flow, in at least some embodiments, the first tank 52 and/or the second tank 64 may provide the makeup flow as well or instead of the third tank. As discussed above, typically the first, second and third tanks 52, 64 and 66, respectively, are interconnected with one another, so the any fluid flowing from one those tanks to one of the hydraulic cylinders 22 or 24 may come from one of those tanks. Furthermore, it will be understood that while FIG. 4B has been explained with respect to a cylinder-to-cylinder regeneration, in at least some embodiments, makeup flow may occur in other cylinder-to-cylinder configurations, as well as in in-cylinder regeneration. Also, makeup flow may occur in addition to or instead of supplemental flow.

Thus, by virtue of providing a combination of regeneration flow, makeup flow and supplemental flow through the monospool assembly 74, an efficient and effective hydraulic system may be achieved.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A hydraulic system, comprising:
a first hydraulic cylinder;
a second hydraulic cylinder;
a first valve arrangement in fluid communication with the first hydraulic cylinder;
a second valve arrangement in fluid communication with the second hydraulic cylinder; and
a monospool assembly in fluid communication with the first hydraulic cylinder and the second hydraulic cylinder, the monospool assembly capable of facilitating at least one of a cylinder-to-cylinder regeneration flow, makeup flow and supplemental flow to at least one of the first hydraulic cylinder and the second hydraulic cylinder.

2. The hydraulic system of claim 1, further comprising:
a first pump in fluid communication with the first hydraulic cylinder at least indirectly through the first valve arrangement; and
a second pump in fluid communication with the second hydraulic cylinder at least indirectly through the second valve arrangement, the first and the second pumps capable of providing the supplemental flow to at least one of the first hydraulic cylinder and the second hydraulic cylinder.

3. The hydraulic system of claim 1, wherein each of the first valve arrangement and the second valve arrangement includes a plurality of independent metering valves.

4. The hydraulic system of claim 1, wherein the first valve arrangement comprises:
a head-end supply valve in fluid communication with a head-end chamber of the first hydraulic cylinder to supply fluid thereto;
a head-end drain valve in fluid communication with the head-end chamber of the first hydraulic cylinder to drain fluid therefrom;
a rod-end supply valve in fluid communication with a rod-end chamber of the first hydraulic cylinder to supply fluid thereto; and
a rod-end drain valve in fluid communication with the rod-end chamber of the first hydraulic cylinder to drain fluid therefrom.

5. The hydraulic system of claim 1, wherein the second valve arrangement comprises:
a head-end supply valve in fluid communication with a head-end chamber of the second hydraulic cylinder to supply fluid thereto;
a head-end drain valve in fluid communication with the head-end chamber of the second hydraulic cylinder to drain fluid therefrom;
a rod-end supply valve in fluid communication with a rod-end chamber of the second hydraulic cylinder to supply fluid thereto; and
a rod-end drain valve in fluid communication with the rod-end chamber of the second hydraulic cylinder to drain fluid therefrom.

6. The hydraulic system of claim 1, wherein the monospool assembly comprises a combiner valve to at least one of allow and restrict the cylinder-to-cylinder regeneration flow and the supplemental flow.

7. The hydraulic system of claim 6, wherein the combiner valve has a first position to restrict the cylinder-to-cylinder regeneration flow and the supplemental flow and a second position to allow the cylinder-to-cylinder regeneration flow and the supplemental flow from a first pump to the second hydraulic cylinder and from a second pump to the first hydraulic cylinder.

8. The hydraulic system of claim 1, wherein the monospool assembly is in fluid communication with a tank.

9. A method of regenerating fluid using a hydraulic system, the method comprising:
providing a first hydraulic cylinder, a second hydraulic cylinder, a first valve arrangement in fluid communication with the first hydraulic cylinder, a second valve arrangement in fluid communication with the second hydraulic cylinder, a monospool assembly in fluid communication with both the first hydraulic cylinder and the second hydraulic cylinder, the monospool assembly capable of facilitating a cylinder-to-cylinder regeneration flow between the first hydraulic cylinder and the second hydraulic cylinder;
directing regenerative fluid from one of the first hydraulic cylinder and the second hydraulic cylinder to the monospool assembly; and
directing the regenerative fluid from the monospool assembly to the other of the one of the first hydraulic cylinder and the second hydraulic cylinder.

10. The method of claim 9, further comprising draining excessive regenerative fluid into a tank.

11. The method of claim 9, further comprising directing pressurized fluid from a pump to at least one of the first hydraulic cylinder and second hydraulic cylinder when a supplemental flow is needed.

12. The method of claim 9, wherein the monospool assembly comprises a combiner valve and for the in-cylinder regeneration, the combiner valve is set to restrict flow of the regenerative fluid between the first hydraulic cylinder and the second hydraulic cylinder and, for the cylinder-to-cylinder regeneration, the combiner valve is set to permit flow of the regenerative fluid between the first hydraulic cylinder and the second hydraulic cylinder.

13. The method of claim 9, further comprising providing a makeup flow from a tank to one or both of the first hydraulic cylinder and the second hydraulic cylinder.

14. The method of claim 13 wherein the makeup flow is employed when a supplemental flow from a pump is not sufficient.

15. The method of claim 9, wherein the cylinder-to-cylinder regeneration comprises:
directing the regenerative fluid from a head-end chamber of one of the first hydraulic cylinder and the second hydraulic cylinder to the monospool assembly; and
directing the regenerative fluid from the monospool assembly through a combiner valve to a rod-end chamber or the head-end chamber of the other of the first hydraulic cylinder and the second hydraulic cylinder.

16. The method of claim 9, wherein the cylinder-to-cylinder regeneration comprises:
directing the regenerative fluid from a rod-end chamber of one of the first hydraulic cylinder and the second hydraulic cylinder to the monospool assembly; and
directing the regenerative fluid from the monospool assembly through a combiner valve to the rod-end chamber or a head-end chamber of the other of the first hydraulic cylinder and the second hydraulic cylinder.

17. A work machine, comprising:
an engine;
a work implement; and
a hydraulic system for operating the work implement, the hydraulic system comprising (a) a first hydraulic cylinder; (b) a second hydraulic cylinder; (c) a first valve arrangement in fluid communication with the first hydraulic cylinder; (d) a second valve arrangement in fluid communication with the second hydraulic cylinder; (e) a monospool assembly in fluid communication with both the first hydraulic cylinder and the second hydraulic cylinder, the monospool assembly capable of facilitating cylinder-to-cylinder regeneration flow, makeup flow and supplemental flow to at least one of the first hydraulic cylinder and the second hydraulic cylinder.

18. The work machine of claim 17, wherein the work machine is an excavator.

19. The work machine of claim 17, wherein the hydraulic system further comprises a first pump in fluid communication at least indirectly with the first hydraulic cylinder through the first valve arrangement and a second pump in fluid communication at least indirectly with the second hydraulic cylinder through the second valve arrangement.

20. The work machine of claim 17, wherein the monospool assembly is at least indirectly in fluid communication with a tank and further includes a combiner valve to facilitate the cylinder-to-cylinder regeneration.
